(19) United States
(12) Patent Application Publication
(10) Pub. No.: US 2013/0230378 A1
(43) Pub. Date: Sep. 5, 2013

(54) WINCH APPARATUS

(71) Applicant: TAIT TOWERS MANUFACTURING, LLC, Lititz, PA (US)

(72) Inventors: Scott FISHER, Las Vegas, NV (US); Nathan Hoover CROSS, Lancaster, PA (US)

(73) Assignee: Tait Towers Manufacturing, LLC, Lititz, PA (US)

(21) Appl. No.: 13/800,972

(22) Filed: Mar. 13, 2013

Related U.S. Application Data
(63) Continuation-in-part of application No. 13/302,536, filed on Nov. 22, 2011.

(51) Int. Cl. B66D 1/50; B66D 1/12

(52) U.S. Cl. CPC B66D 1/50; B66D 1/12
USPC 414/800; 254/338; 254/362

(57) ABSTRACT

A tensioning device for a winch assembly includes a pair of wheels operatively connected to a winch assembly and is configured to grippingly receive a cable extending therebetween from a rotatably movable drum configured to extend/retract the cable with respect to the winch assembly. The pair of wheels continuously maintains a predetermined tension to the cable extending between the pair of wheels and the drum during operation of the winch assembly.

### FIELD

The disclosure is generally related to a motorized winch for positioning a load. More particularly, the disclosure includes a motorized, winch apparatus for manipulating staging equipment.

### BACKGROUND

When presenting events such as concerts or theatre productions, winches, pulleys and other equipment are commonly used for support, movement and manipulation of performers and various equipment, such as, lighting, sound, scenery and props. Remotely controlled motorized winches are commonly used to rapidly and reliably move performers and equipment during such productions. There currently remains a need in the staging industry to provide a more compact winch assembly that includes a zero fleet angle, high torque, an effective free-wheeling design, and a cable tensioning device that provides smooth movement and manipulation of loads.

What is needed is a method and apparatus that addresses the above-referenced issues and concerns. The present device addresses the issues listed above.

### SUMMARY

Aspects of embodiments of the present disclosure include at least the following:
Zero Fleet Angle Winch—Providing a winch with cables that extend and retract cables with respect to the winch housing at fixed angles relative to the drum head.
Compact high torque drive assembly—Providing an arrangement of a high speed servomotor with integral gear box and multiple drums; equipment spaced more efficiently, yet capable of delivering high torque.
Effective free-wheeling design—Providing a winch assembly that can rotate relative to its base, both freely about a vertical axis and freely about a horizontal axis in response to changes in position of the load element.
Cable tensioning device—Providing a device for maintaining cable tension between the drum and the device, maintaining proper cable alignment along the drum, promoting proper operation of the winch assembly, as well as providing precise control of cable extension/retraction.

An aspect of embodiments of the present disclosure includes a system that provides a winch apparatus for manipulating loads associated with public performances, such as performers and staging equipment.

In an exemplary embodiment, a tensioning device for a winch assembly includes a pair of wheels operatively connected to a winch assembly and is configured to grippingly receive a cable extending therebetween from a rotatably movable drum configured to extend/retract the cable with respect to the winch assembly. The pair of wheels continuously maintains a predetermined tension to the cable extending between the pair of wheels and the drum during operation of the winch assembly.

In a further exemplary embodiment, a winch assembly includes a housing, and a rotatably movable drum configured to extend/retract cable with respect to the housing at a zero fleet angle. A motor rotatably moves the drum, and a controller controls the motor. A tensioning device is operatively connected to the housing and configured to continuously maintain a predetermined tension to cable extending between the tensioning device and the drum during operation of the winch assembly.

In a further exemplary embodiment, a method of supporting a load includes providing a winch assembly having a housing, and a rotatably movable drum configured to extend/retract cable with respect to the housing at a zero fleet angle. The method further includes providing a motor for rotatably moving the drum and a controller for controlling the motor. The method further includes a tensioning device operatively connected to the housing and configured to continuously maintain a predetermined tension to cable extending between the tensioning device and the drum during operation of the winch assembly. The method further includes moving the load supported by the cable extending from the housing.

Another aspect includes providing a winch apparatus with a tensioning device and cable guides to maintain a zero fleet angle of the cable relative to the drums for ease of manipulating staging equipment.

An additional aspect includes a motorized tensioning device for actively maintaining a predetermined cable tension between the drums and the tensioning device.

Still another aspect is to provide a winch apparatus with a high speed servomotor and dual drum arrangement with compact integral gear box that provides high torque.

A further aspect is to provide a winch apparatus with bearing assembly and mounting bracket pivot that enable the winch to rotate horizontally and pivot vertically in response to load element changes in angle and rotation.

It is to be understood that an embodiment of a winch apparatus may include one or more of the above-described aspects.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 shows a perspective view of a winch assembly according to an exemplary embodiment of the disclosure.

FIG. 2 shows a top cutaway of the winch housing of FIG. 1 according to an exemplary embodiment of the disclosure.

FIG. 3 shows a side cutaway view of the winch housing of FIG. 1 according to an exemplary embodiment of the disclosure.

FIG. 4 shows a perspective view of the winch housing of FIG. 1 according to an exemplary embodiment of the disclosure.

FIG. 5 shows an exposed perspective view of the winch housing components of FIG. 4 according to an exemplary embodiment of the disclosure.

FIG. 6 shows an exposed top view of the winch housing components of FIG. 4 according to an exemplary embodiment of the disclosure.

FIG. 7 shows an exposed side view of the winch housing components of FIG. 4 according to an exemplary embodiment of the disclosure.

FIG. 8 shows an exposed perspective view of the winch housing components of FIG. 4 according to an exemplary embodiment of the disclosure.

FIG. 9 shows an exposed end view of the winch housing components of FIG. 4 according to an exemplary embodiment of the disclosure.

FIG. 10 shows a perspective view of a winch assembly according to an alternate embodiment of the disclosure.

FIG. 11 shows a cross section taken along line 11-11 of FIG. 10 of an embodiment of a rotation device of the disclosure.

FIG. 12 shows a perspective view of a securing device of a winch assembly according to an alternate embodiment of the disclosure.

FIG. 13 shows a top cutaway of the winch housing of FIG. 1 according to an exemplary embodiment of the disclosure.

FIG. 14 shows a perspective view of the winch housing of FIG. 1 according to an exemplary embodiment of the disclosure.

FIG. 15 shows an exposed perspective view of the winch housing components of FIG. 4 according to an exemplary embodiment of the disclosure.

### DETAILED DESCRIPTION

Provided is an apparatus to rapidly extend and retract cable with respect to a winch assembly in order to move or manipulate a load, such as performers or staging equipment associated with a performance. What follows are exemplary embodiments.

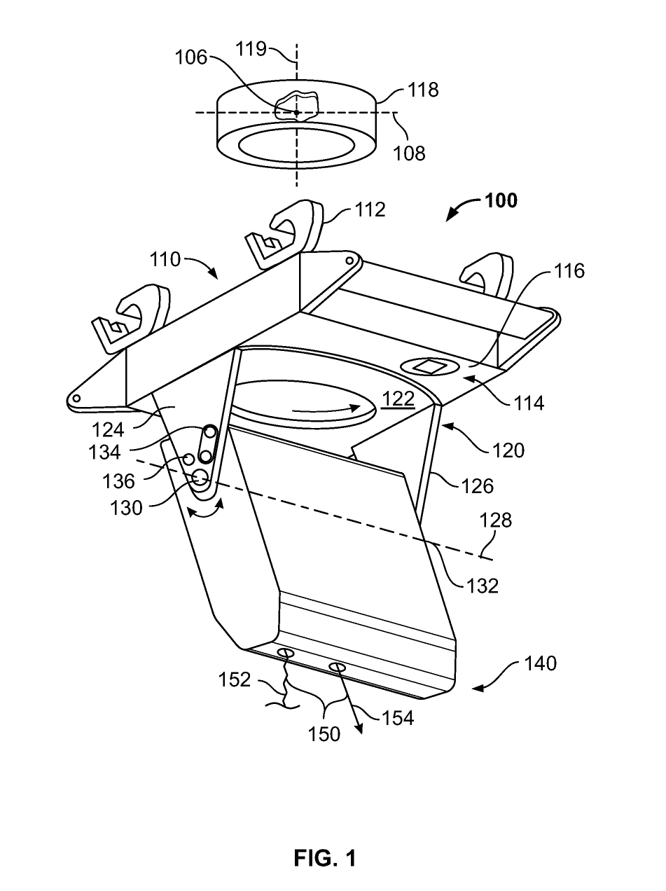

FIG. 1 shows a perspective view of a winch assembly 100 according to an embodiment. The winch assembly 100 includes a base 110, a mounting bracket 120, and a winch housing 140. Base 110 includes a plurality of securing devices 112 that may be clamps or clips used to connect the base 110 to adjacent support structural (not shown) such as beams, trusses or racks. In one embodiment, securing device 112 may be configured to secure base 110 to support structure that is movable during operation of winch assembly 100. In another embodiment, securing device 112 may be configured to movably secure base 110 along support structure during operation of winch assembly 100. In yet another embodiment, securing device 112 may both movably secure base 110 along support structure, as well as be secured to support structure that is movable during operation of winch assembly 100. In another embodiment, base 110 may be attached to the structure so as to be mounted in a substantially horizontal position, allowing mounting bracket 120 and winch housing 140 to be operatively connected to a portion 116, such as a panel of base 110. In another embodiment securing device(s) 112 of base 110 may be operatively connected to support structure in a non-horizontal angle or orientation.

Base 110 includes a controller 114 disposed within the base, which controller may include microprocessors or a CPU for control of the winch assembly 100. The controller 114 electrically connects to a cable (not shown) or other source of power and control wiring for operating the winch assembly 100. The cable may be routed from the controller 114 through an opening formed in the mounting bracket 120 and continued through an adjacent portion of the winch housing 140. In one embodiment, controller 114 may also be integrated into or operate as a larger control system that can provide additional control operations or instructions to other components, e.g., lights, sound, video, that may be used in conjunction with a performance.

In one embodiment, the mounting bracket 120 includes a mounting plate 122, a first arm 124 and a second arm 126. Mounting plate 122 is configured to operatively connect portion 116 of base 110. As shown in FIG. 1 prior to installation, a rotation device 118, such as a bearing assembly or other means for facilitating rotation may be disposed in a central portion of mounting plate 122 located within base 110. In other embodiments, the rotation device may be located in a non-central portion of the mounting plate. In another embodiment, rotation device 118 may be configured for manual control to restrict freedom of rotation of winch housing 140, including variable resistance to rotational movement, such as by adjustment of friction between contacting surfaces between base 110 and mounting plate 122, if desired. A fastener, lever, other suitable mechanical device or arrangement, including an automated control that is controllable such as by controller 114 may be used to achieve the friction adjustment. Rotational device 118 operates such that the mounting bracket 120 may rotate about axis 119 with respect to base 110. In one embodiment, axis 119 may be placed in a substantially vertical position. In other embodiments, axis 119 may be placed in a non-vertical position. In a further embodiment, rotation device 118 may be a spherical bearing, permitting angular rotation about a central point in two orthogonal directions. For example, as shown in FIG. 1, spherical bearing 118 has a center point 106, permitting rotation about axis 119 and axis 108, which is orthogonal to axis 119. In an embodiment that includes spherical bearing 118, base 110 may incorporate sufficient rotational movement about axes 108, 119, such that winch housing 140 may be affixed to one portion of the spherical bearing, such as a spherical ball portion (not shown) with base 110 affixed to another portion of the spherical bearing, such as a raceway (not shown) configured to rotatably receive the spherical ball portion of the spherical bearing. In other words, in such an embodiment, mounting bracket 120 may not be required. In yet another embodiment, the portions of the spherical bearings affixed to respective base and winch housing may be reversed.

As further shown in FIG. 1, first arm 124 and second arm 126 of mounting bracket 120 may extend generally outward from the mounting plate 122. Ends of first arm 124 and second arm 126 opposite base 110 include pivot 130 and pivot 132 respectively, which are pivotably connected to opposing sides of winch housing 140. Pivots 130 and 132 operate to allow the winch housing 140 to pivot relative to the mounting bracket 120 about an axis 128, which as shown in FIG. 1, is a horizontal axis. Pivot 132 (opposite pivot 130) may be configured to allow the winch housing 140 to be free-rotating about axis 128, except that limit stops may be provided at predetermined maximum angles of rotation. In one embodiment, there may be multiple limit stops, providing adjustment, depending upon the application or special restrictions associated with the supporting structure or performance, or other reasons. Pivot 130 may be configured for manual control to restrict the degree of freedom of rotation of winch housing 140, including variable resistance to rotational movement, such as by adjustment of friction between contacting surfaces of first arm 124 and winch housing 140, or by springs (not shown) operatively connected to pivot 130 and may also include limit stops provided at predetermined maximum angles of rotation. As shown in FIG. 1, lever 134 is disposed on first arm 124 adjacent to pivot 130, and may be configured to provide either locking or free operation of pivot 130. As further shown in FIG. 1, adjustment knob 136 is disposed on first arm 124 adjacent to pivot 130, and may be configured to adjust the degree of freedom of rotational movement available in pivot 130. Pivots 130, 132 in combination with rotation device 118, provides a substantially free-wheeling arrangement. In one embodiment in which rotation device 118 is a spherical bearing, a substantially free-wheeling arrangement may be achieved without the addition of pivots 130, 132.

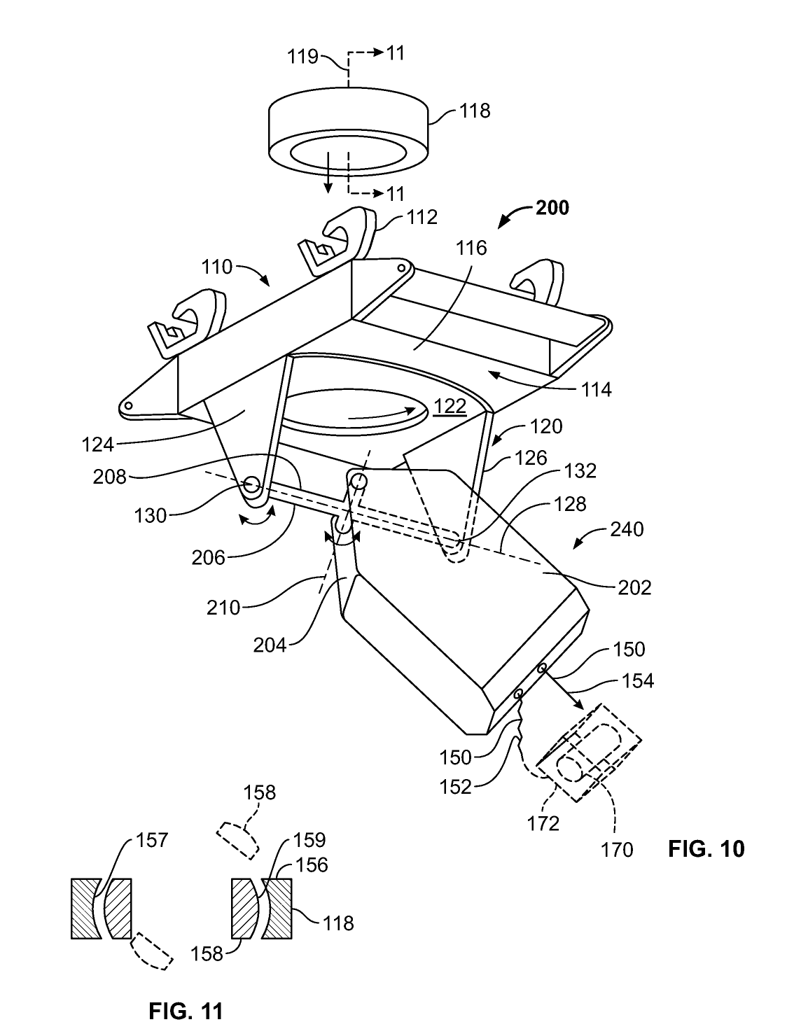

As shown in FIGS. 10-11, an alternate embodiment of winch assembly 200 is now discussed. Winch assembly 200 includes a multiple-axis rotation device 206, such as a universal joint, including an “X-shaped” frame 208. As further shown in FIG. 10, a first set of opposed ends of frame 208 is rotatably connected to respective pivots 130, 132 of arms 124, 126. As yet further shown in FIG. 10, a second set of opposed ends of frame 208 is rotatably connected about an axis 210 to respective opposed sides 202, 204 of winch housing 240. In one embodiment, winch assembly 200 may be generally arranged such that rotation axes 119, 128, 210 are orthogonal or mutually perpendicular to each other. As further shown in FIG. 11, rotation device 118 is a cross section taken along line 11-11 of FIG. 10 of an embodiment of a spherical bearing having an outer race 156 and including a concave peripheral surface 157 that corresponds to a convex peripheral surface 159 of an inner sleeve 158. It is to be understood that base 110 can be configured to support outer race 156 and mounting bracket 120 can be supported by sleeve 158 in one embodiment, although the arrangement could be reversed in another embodiment. In yet another embodiment, rotation device 118 may be a bearing assembly that is not a spherical bearing, and confined to provide rotational movement about a single rotational axis.

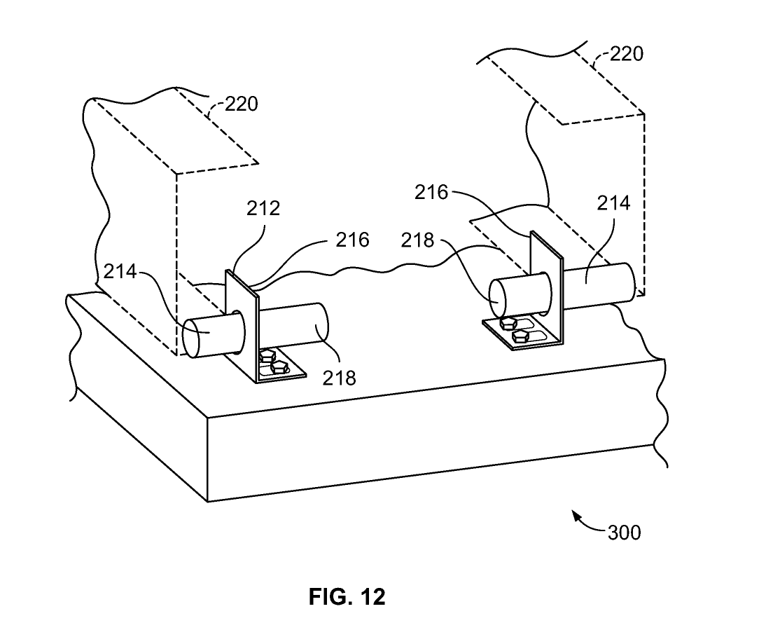

FIG. 12 shows an exemplary embodiment of securing devices 212 configured for supporting a winch assembly 300. As further shown in FIG. 12, securing devices 212 include a plurality of brackets 216 having a roller 214 to movably contact support structure 220 for supporting winch assembly 300. Motors 218 may be provided to controllably rotate roller 214 along a surface of support structure 220, which motors are controllable such as by controller 114 (FIG. 1). In other words, securing devices 212 permit winch assembly 300 to be movable with respect to support structure 220.

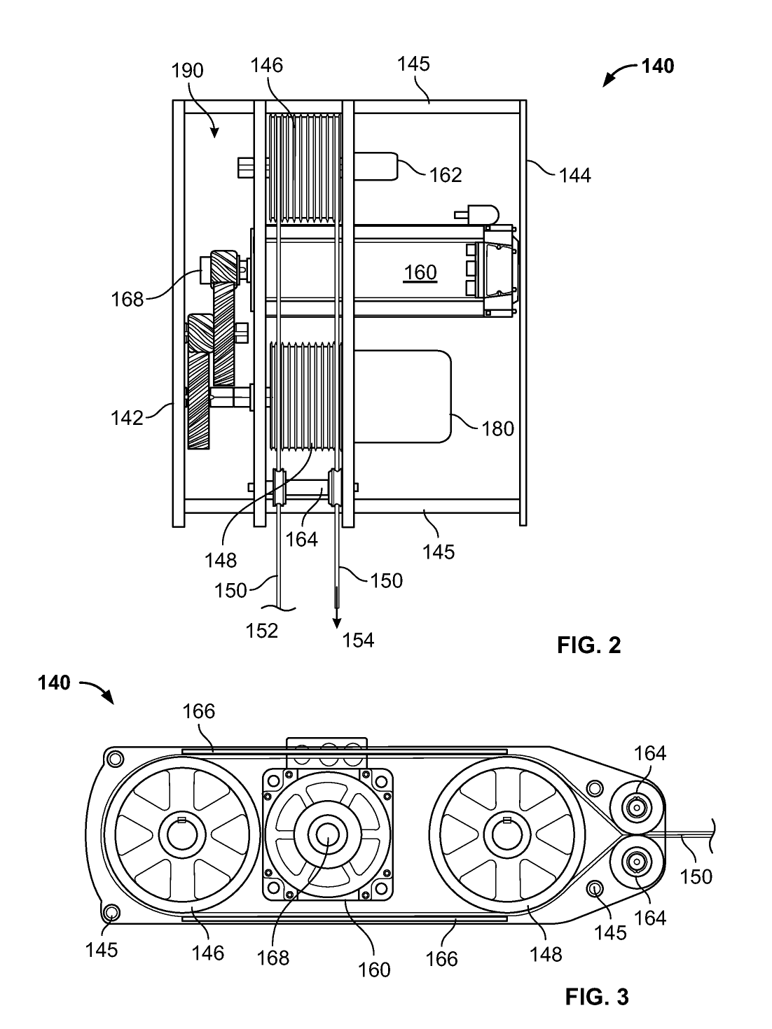

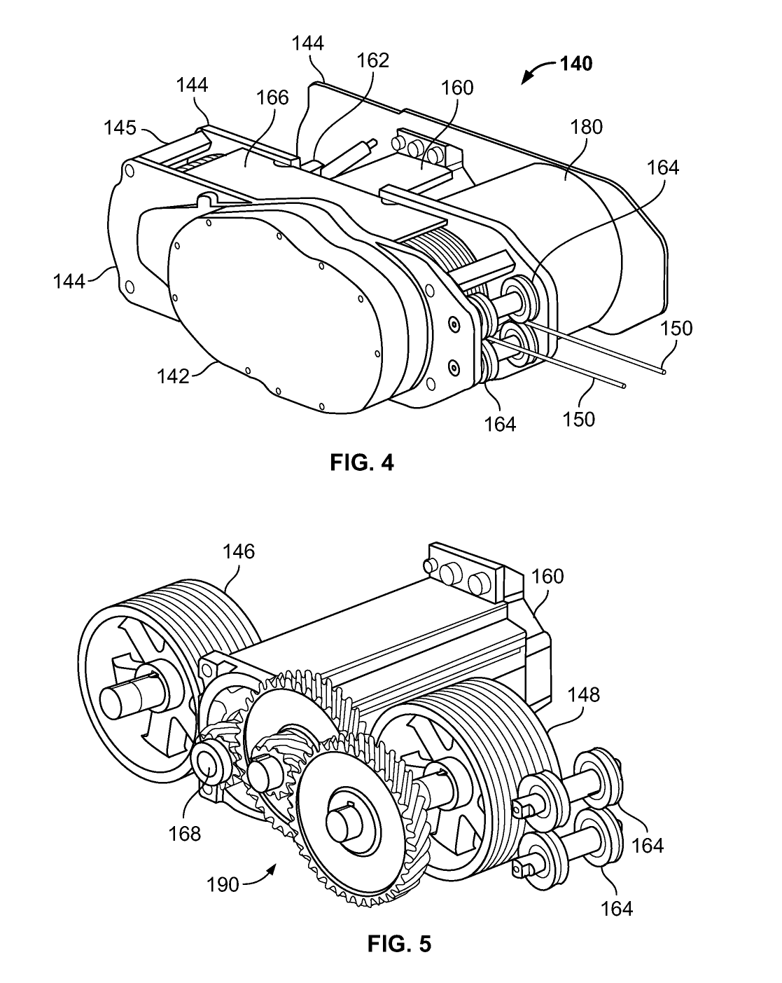

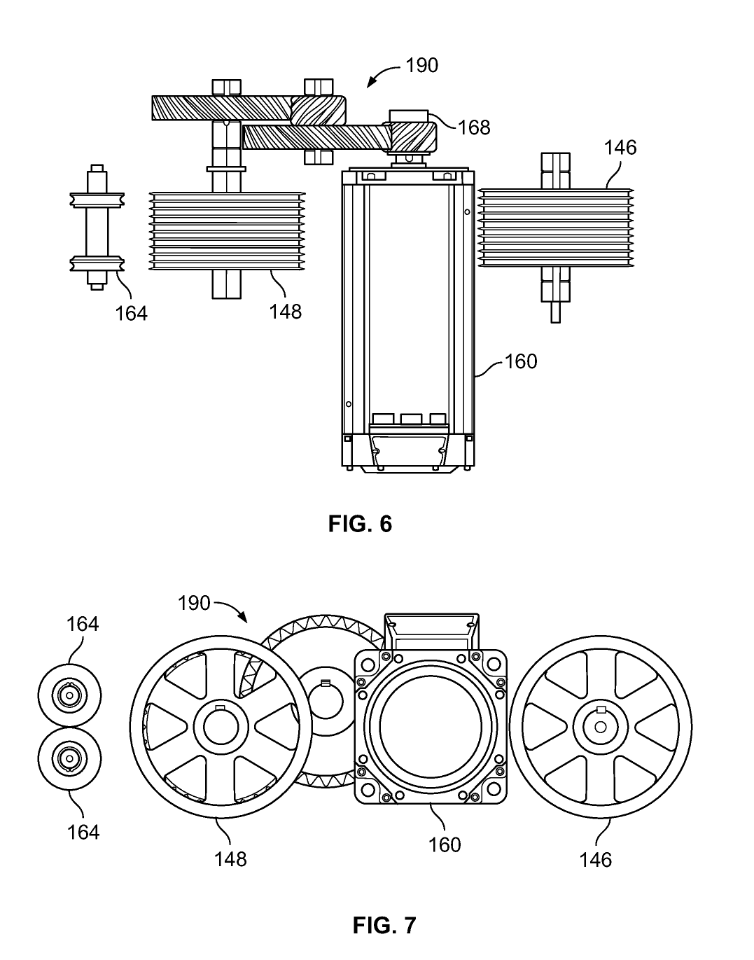

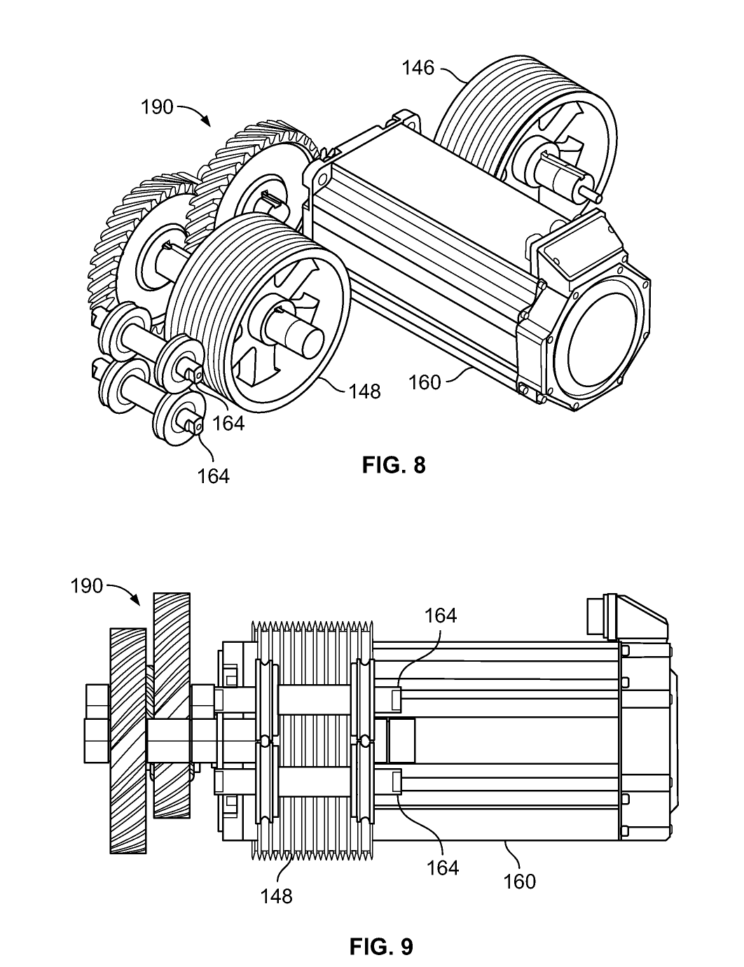

FIGS. 2-9 show views of the winch housing 140 according to an embodiment. The winch housing 140 includes gear casing 142, support frames or plates 144, primary or first drum 146, secondary or second drum 148, cable 150, servomotor 160, position encoder 162, grip pulleys 164, cable guides 166, primary brake system (not shown), secondary brake system 180, and gear assembly 190. The support frames 144, such as plates may be aligned generally parallel with each other and may be interconnected at a predetermined spacing by a plurality of support members 145.

The primary or first drum 146 and secondary or second drum 148 may be mounted in a parallel stacked relation on opposite sides of the servomotor 160, and may be supported by the inner support frames 144. The drums 146, 148 may be helically grooved to allow for a single layer of the cable 150 to be wound around the drums. Cable 150 may be synthetic or wire material, and is of predetermined strength, as required by the application. The cable 150 may be configured to travel around both drums prior to extending exterior of the winch housing 140 from one end of the winch housing. When winch housing 140 is pivoting in response to the load or load elements, e.g., during positional shifting of the load or load elements, the cable keepers or guides 166 serve to maintain the cable 150 in position, i.e., maintain the cable in contact with the drum grooves, as the cable is traveling around the drums. Grip pulleys 164 may be disposed near one end of the winch housing, and may be spring loaded in order to help maintain tension and position of cable 150 at a fixed angle relative to the drums as the cable is extended or retracted with respect to the winch housing. In other words, grip pulleys 164 permit the winch assembly to operate at a zero fleet angle.

Cable 150 includes a feed, feed line, dead end line, or feed portion 152, or a similar term, and an opposed load line, live end line, load portion or load carrying portion 154, or a similar term. In other words, cable 150 is composed of a single, continuous length of material, with one end defining feed portion 152 and the other end defining load carrying portion 154. The feed portion 152 of cable 150 may be anchored or may be wound about a separate storage spool 170 secured in a housing 172, such as shown in FIG. 10. In one embodiment, housing 172 is configured to be connected to a side of winch assembly 240. Alternately, feed portion 152 may loosely extend exterior of the housing of winch assembly 240. The load carrying portion 154 may be operatively secured to a load, such as a performer, lights, speakers, scenery or other elements (not shown). As the load changes position relative to the winch assembly 100, the winch housing 140 may react by rotating or pivoting relative to the base 110. In one embodiment, in which securing devices 112 are secured to movable structure or permit movement of the winch assembly with respect to supporting structure (e.g., controlled movement along flanges of an I-beam) winch housing 140 may move in combination with rotational or pivoting movement of the winch housing relative to base 110.

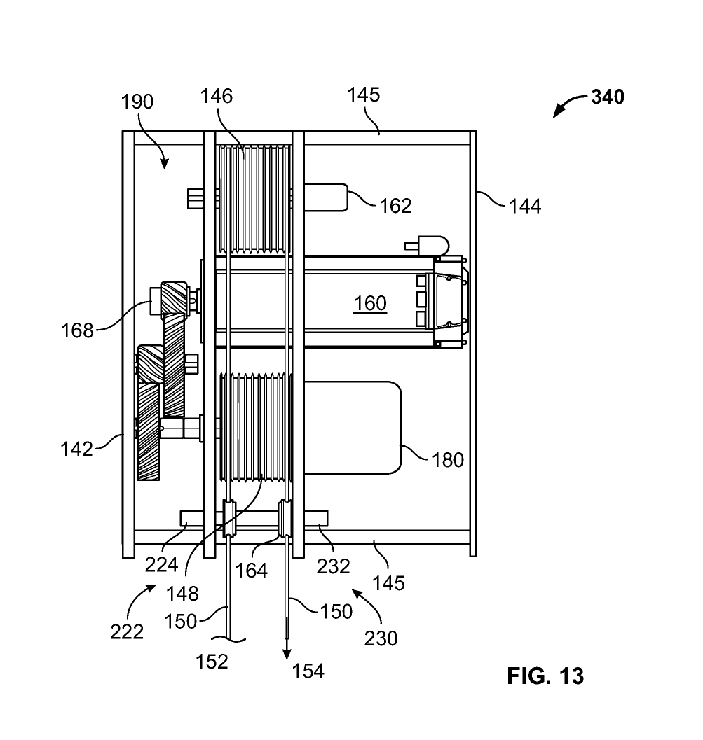

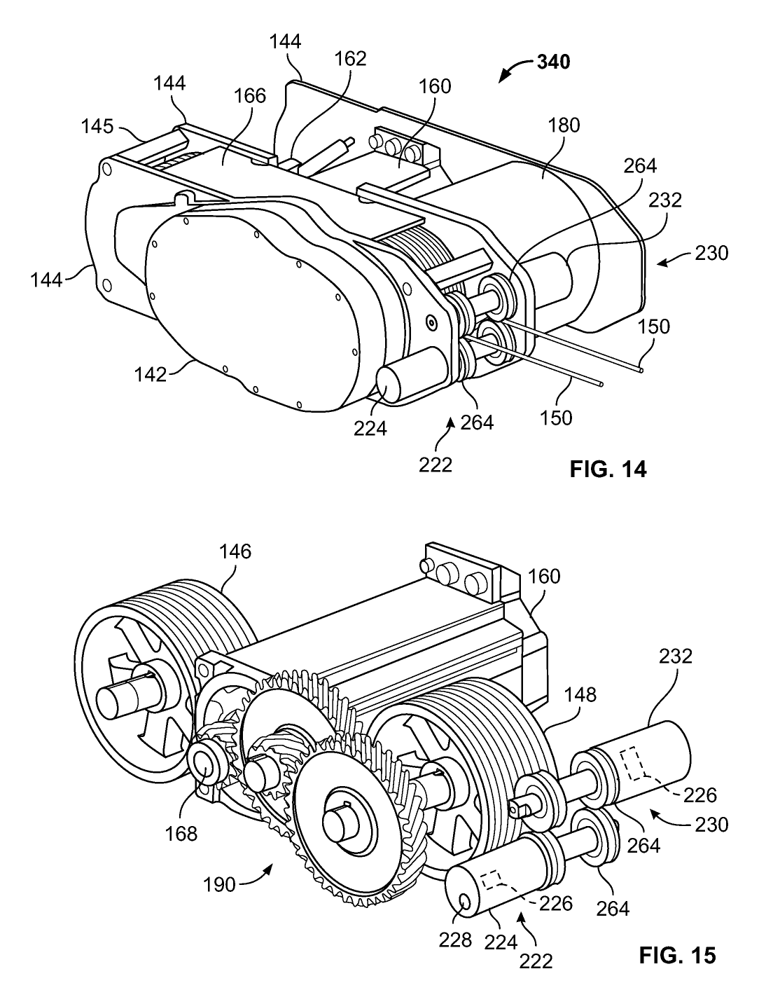

FIGS. 13-15 collectively show an exemplary embodiment of a winch assembly 340 including tensioning devices 222, 230 for continuously maintaining a predetermined tension or a predetermined tensile force to cable 150 extending between either or both of drums 146, 148 and tensioning devices 222, 230, prior to cable 150 extending exterior of the housing of winch assembly 340. Such continuous maintenance of cable tension is not possible by use of springs associated with wheels 264 throughout the full range of operating conditions of winch assembly 340. As further shown in FIGS. 13-15, tensioning devices 222, 230 each include a pair of wheels 264 configured to grippingly receive cable 150 extending between at least one of rotatably movable drums 146, 148 associated with extention/retraction of cable 150 with respect to the winch assembly 340. Wheels 264 are composed of a suitable material having a high coefficient of the static friction between the contacting wheel surface and the surface of the cable. In one embodiment, a coding having a high coefficient of static friction may be applied to the surface of wheels 264. In one embodiment, wheels 264 have an inwardly cupped peripheral surface, such as is associated with pulleys, permitting improved conformal contact between the wheel surface and the surface of the cable 150.

As shown collectively shown in FIGS. 13-15, a motor 224 is operatively connected to a wheel 264 for urging the wheel 264 or pair of wheels 264 to rotatably move as part of tensioning device 222. A motor 232 is operatively connected to a wheel 264 for urging the wheel 264 or pair of wheels 264 to rotatably move has part of tensioning device 230. In one embodiment, the arrangement of the pair of wheels 264 achieves mutual contact along a tangent of each of the wheels. In another embodiment, the pair of wheels 264 are maintained in sufficiently close proximity to one another such that when cable 150 is directed to extend between the pair of wheels 264, opposed portions of the surface of cable 150 are brought into conformal contact with a corresponding surface of each of the pair of wheels 264. In another embodiment, the arrangement of the pair of wheels 264 is a combination of the two previous embodiments. As a result, activation of motor 224 operatively connected to wheel 264 of tensioning device 222 directly urges rotational movement of the wheel 264, with the other wheel 264 of the wheel pair being urged to rotate in opposite rotational movement as a result of the conformal contact between one or more of the proximate surfaces of the pair of wheels 264 or the mutual conformal contact between opposed surfaces of the cable and the corresponding surfaces of each of the pair of wheels 264. In other words, one wheel 264 would be considered the drive wheel, while the other wheel 264 of the pair of wheels would be considered an idler wheel. In one embodiment, each wheel 264 of a pair of wheels can be operatively connected to separate motors 224 and configured to rotate in opposed rotational directions.

Motors 224, 232 are high-speed, low torque motors, such as servomotors, and are configured to continuously maintain a predetermined level of tension on cable 150 between the pair of wheels 264 and the drum, such as first drum 146 and second drum 148 previously discussed, the cable 150 extending between the particular drum and the pair of wheels 264 during operation of winch assembly 340. In one embodiment, at least one of motors 224, 232 is configured to continuously maintain a predetermined level of tension on cable 150 between the pair of wheels 264 and the drum during non-operation of winch assembly 340. In one operating mode of motors 224, 232, the corresponding pair of wheels 264 are urged to rotate in a direction that would extend cable 150 from the housing of winch assembly 340. During operation of winch assembly 340 in which the drum (first drum 146 or second drum 148) is urged to rotate such that cable 150 is retracted into the housing, the high torque motor 160 rotatably driving the drum easily overcomes or overpowers the motor 224, 232 driving the pair of wheels 264, with the counter-torque generated by motor 224, 232 achieving a predetermined tension in the cable 150.

However, during operation of winch assembly 340 in which the drum (first drum 146 or second drum 148) is urged to rotate such that cable 150 is extended from the housing, i.e., the motor 224, 232 and the high torque motor 160 are rotatably driving the cable in the same direction, motor 224, 232 is configured to “attempt to” accelerate more quickly and continuously “attempt” to produce a higher cable feed rate by pair of wheels 264 than achieved by motor 160 rotably driving the drum. In other words, while the high torque motor rotatably driving the drum easily overcomes or overpowers the motor 224, 232, the torque generated by motor 224, 232 as a result of motor 224, 232 attempting to produce a greater cable extention rate between the pair of wheels 264 than the cable extention rate produced by drum motor 160 results in achieving and continuously maintaining a predetermined tension in the cable 150.

It is to be understood that motor 224, 232 can be configured to operate and achieve the results as described above over the entire operating range of drum motor 160.

In summary, the continuous difference in feed direction and/or the continuous difference in speed of the drum motor 160 as compared to that of motor 224, 232 as described above, results in achieving and continuously maintaining a predetermined tension in the cable 150 between the drum and the pair of wheels 264.

In one embodiment, motor 224, 232 continuously maintains a predetermined tension of cable 150 between a drum (first drum 146 or second drum 148) and the pair of wheels 264 during non-operation of winch assembly 340. In one embodiment, motor 224, 232 includes an anti-rotation device 226 that can be actuated immediately prior to non-operation of winch assembly 340 such that motor 224, 232 cannot rotate when winch assembly 340 is non-operational, thereby maintaining a predetermined tension in the cable 150 between the drum and the pair of wheels 264.

In one embodiment, service personnel may be required to work on winch assembly 340. As a result, an override feature, such as manually actuatable override feature 228 can be provided so that cable 150 can be extended/retracted through pairs of wheels 264.

It is to be understood that at least one of the pair of wheels 264 and motor 224, 232 can be positioned interior of a housing of the winch assembly, protecting these components or personnel from inadvertent contact with these components.

It is to be understood that the pair of wheels 264 are configured to maintain cable 150 at a zero fleet angle relative to the drum (first drum 146 or second drum 148).

In one embodiment, controller 114 (FIG. 1) controls each of servomotor or motor 160 and motor 224, 232.

The cable 150 is electrically coupled (not shown) to servomotor 160, and may serve to relay the feedback signal from the position encoder 162. Remote controls (not shown), such as a computer or other user interface, may be operatively connected to the cable to allow for operation of servomotor 160, and to provide control for variable speed, acceleration and deceleration of the motor. A drive shaft 168 on the servomotor 160 is mechanically coupled to the gear assembly 190. The gear assembly 190 may be composed of a set of meshing gears, including helical, spur or other suitable type of gear that may be mechanically coupled to the primary or first drum 146 and secondary or second drum 148, or may be coupled to only one of the two drums. The gear casing 142 may be configured to substantially enclose the gear assembly 190, providing protection and safety. The gear assembly 190 provides a speed reducing mechanism to reduce the rotational speed of the motor to an output speed suitable for driving rotation of the drums.

The primary brake system (not shown) may be configured to retard or prevent rotation of the gear assembly adjacent the servomotor drive shaft 168. In one embodiment, the primary brake system is a double spring applied brake, and remotely controlled. As shown in the figures, the secondary brake system 180 may be operatively connected to the secondary or second drum 148, and operates to retard or prevent rotation of the drum.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A tensioning device for a winch assembly comprising:
a pair of wheels operatively connected to a winch assembly and configured to grippingly receive a cable extending therebetween from a rotatably movable drum configured to extend/retract the cable with respect to the winch assembly;
wherein the pair of wheels continuously maintaining a predetermined tension to the cable extending between the pair of wheels and the drum during operation of the winch assembly.

2. The tensioning device of claim 1, wherein at least one wheel of the pair of wheels is urged into rotation by a motor.

3. The tensioning device of claim 2, wherein the motor is a servomotor.

4. The tensioning device of claim 2, wherein at least one of the pair of wheels and the motor is positioned interior of a housing of the winch assembly.

5. The tensioning device of claim 1, wherein the pair of wheels are configured to maintain the cable at a zero fleet angle relative to the drum.

6. The tensioning device of claim 1, wherein the pair of wheels continuously maintains a predetermined tension to the cable extending between the tensioning device and the drum during operation and non-operation of the winch assembly.

7. The tensioning device of claim 6, wherein the motor includes an anti-rotation device that is actuated immediately prior to non-operation of the winch assembly.

8. The tensioning device of claim 7, wherein the anti-rotation device includes a manually actuatable override feature.

9. A winch assembly comprising:
a housing;
a rotatably movable drum configured to extend/retract cable with respect to the housing at a zero fleet angle;
a motor for rotatably moving the drum;
a controller for controlling the motor; and
a tensioning device operatively connected to the housing and configured to continuously maintain a predetermined tension to cable extending between the tensioning device and the drum during operation of the winch assembly.

10. The winch assembly of claim 9, wherein the tensioning device comprises a pair of wheels configured to grippingly receive cable extending therebetween from the drum.

11. The winch assembly of claim 10, wherein at least one wheel of the pair of wheels is urged into rotation by a motor.

12. The winch assembly of claim 11, wherein the motor is a servomotor.

13. The winch assembly of claim 11, wherein at least one of the pair of wheels and the motor is positioned interior of the housing.

14. The winch assembly of claim 10, wherein the pair of wheels are configured to maintain cable at a zero fleet angle relative to the drum.

15. The winch assembly of claim 9, wherein the tensioning device continuously maintains a predetermined tension to cable extending between the tensioning device and the drum during operation and non-operation of the winch assembly.

16. The winch assembly of claim 15, wherein the motor includes an anti-rotation device that is actuated immediately prior to non-operation of the winch assembly.

17. The winch assembly of claim 16, wherein the motor includes a manually actuatable override feature to the anti-rotation device.

18. A method of supporting a load comprising:
providing a winch assembly comprising:
a housing;
a rotatably movable drum configured to extend/retract cable with respect to the housing at a zero fleet angle;
a motor for rotatably moving the drum; and
a controller for controlling the motor; and
a tensioning device operatively connected to the housing and configured to continuously maintain a predetermined tension to cable extending between the tensioning device and the drum during operation of the winch assembly; and
moving the load supported by the cable extending from the housing.

19. The method of claim 18, wherein the tensioning device comprises a pair of wheels configured to grippingly receive cable therebetween extending from the drum.

20. The tensioning device of claim 2, wherein at least one wheel of the pair of wheels is urged into rotation by a motor.
